(19) United States
(12) Patent Application Publication
(10) Pub. No.: US 2013/0009997 A1
(43) Pub. Date: Jan. 10, 2013

(54) PINCH-TO-ZOOM VIDEO APPARATUS AND ASSOCIATED METHOD

(75) Inventors: Adrian Boak, Woodlawn (CA); Christopher James Runstedler, Cambridge (CA); Etienne Belanger, Kanata (CA); Arun Kumar, Waterloo (CA); Danny Thomas Dodge, Ottawa (CA); Mihal Lazaridis, Waterloo (CA); Michael Clewley, Kitchener (CA); Adrian Nita, Ottawa (CA)

(73) Assignee: RESEARCH IN MOTION LIMITED, WATERLOO (CA)

(21) Appl. No.: 13/176,535

(22) Filed: Jul. 5, 2011

(51) Int. Cl. G09G 5/00; G06F 3/041

(52) U.S. Cl. 345/661; 345/173

(57) ABSTRACT

Full-motion video displayed on a portable communications device such as a tablet personal computer, can be processed “on the fly” to provide a “zoom-in” and “zoom-out” functionality. Image elements are added to video image frames as they are read out from memory and prior to being display on the picture elements (pixels) of a display device in order to make objects depicted in an image file as being larger than how it appears in the original image file. Similarly, image elements are subtracted or deleted from video image frames as they are read from memory and prior to their being displayed in order to make objects depicted in the image frames as being smaller. Video from any source can be zoomed in and zoomed out.

### FIELD OF THE INVENTION

The present disclosure relates generally to a manner by which to facilitate viewing of full-motion video on a portable wireless device such as a so-called “tablet” personal computer or PC. More particularly, the present invention relates to an apparatus, and an associated method, by which full-motion video obtained from a variety of sources can be enlarged or reduced, i.e., “zoomed-in” or “zoomed-out,” using a tactile or input gesture to a touch-sensitive display screen.

### BACKGROUND

Recent years have witnessed the development and deployment of a wide range of electronic devices and systems that provide many new functions and services. Advancements in communication technologies for instance, have permitted the development and deployment of a wide array of communication devices, equipment, and communication infrastructures. Their development, deployment, and popular use have changed the lives and daily habits of many.

Cellular telephone and other wireless communication systems have been developed and deployed and have achieved significant levels of usage. Increasing technological capabilities along with decreasing equipment and operational costs have permitted, by way of such wireless communication systems, increased communication capabilities to be provided at lowered costs.

Early-generation, wireless communication systems generally provided for voice communications and limited data communications. Successor-generation communication systems have provided increasingly data-intensive communication capabilities and services. New-generation communication system, for instance, provide for the communication of large data files at high through-put rates by their attachment to data messages.

Wireless communications are typically effectuated through use of portable wireless devices, which are sometimes referred to as mobile stations. The wireless devices are typically of small dimensions, thereby to increase the likelihood that the device shall be hand-carried and available for use whenever needed as long as the wireless devices positioned within an area encompassed by a network of the cellular, or analogous, communication system. A wireless device includes transceiver circuitry to provide for radio communication, both to receive information and to send information.

Some wireless devices are now provided with additional functionality. Some of the additional functionality provided to a wireless device is communication-related while other functionality is related to other technologies. When so-configured, the wireless device forms a multi-functional device, having multiple functionalities.

The recordation, storage and playback of full-motion video is one functionality now provided to some wireless devices, which include tablet computers equipped with radio frequency transmitters and receivers. Because of the small dimensions of typical wireless devices, and the regular carriage of such devices by users, a wireless device having video playback functionality is desirable to many users. A program, once recorded, can be saved, for example, at a storage element of the wireless device and/or can be viewed on the device or perhaps transferred elsewhere because the television content is defined or kept as a file, which is generally considered to be a named or identified collection of information, such as a set of data bits or bytes used by a program. And, since the recorded image is kept as a file, the file can be appended to a data message and sent elsewhere. The data file forming the image or images is also storable at the wireless device, available subsequently to be viewed at the wireless device.

Various methodologies have been developed by which to facilitate the viewing of video programming or content. A method and apparatus by which video content can be manipulated, i.e., zoomed in and zoomed-out, in order to provide the appearance of enlarging or decreasing the size of objects in a video, would be an improvement over the prior art. It is in light of this background information related to television programming information recording that the significant improvements of the present invention have evolved.

### BRIEF DESCRIPTION OF THE DRAWINGS

FIG. 1 is a front elevation view of a portable communications device having video storage and playback capability;

FIG. 2 is a block diagram of a wireless communications system and a block diagram of a portable communications device depicted in FIG. 1;

FIG. 3 is a block diagram of functional elements of the portable communications device depicted in FIGS. 1 and 2; and

FIG. 4 depicts a method of processing stored video image data files to provide zoom functionality by tactile inputs to a touch-sensitive display screen.

### DETAILED DESCRIPTION

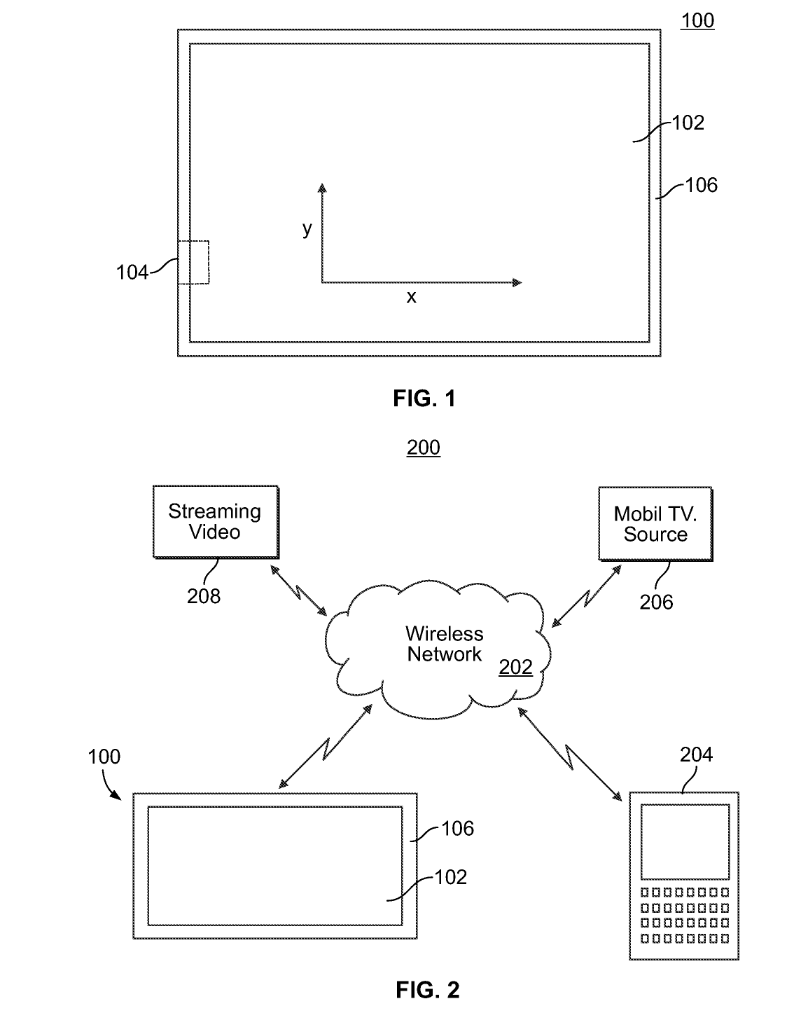

FIG. 1 is a front view of a portable communications device commonly referred to as a tablet computer or simply a tablet 100. The tablet 100 is comprised of a capacitive touch-sensitive display screen 102. Because the display screen 102 is touch-sensitive, a user is able to interact with and operate the device 100 using “gestures.”

Gestures are considered herein to be one or movements of one or more figures across the surface of the display screen 102, while the one or more fingers make contact with the surface of the display screen. As used herein, a gesture can also include a movement of a pen or stylus against the surface of the display screen 102. Using gestures it is thus possible to duplicate the functionality of a conventional prior art mouse and keyboard. Gestures enable a user to scroll, select, open a program, close a program, and as described more fully below “zoom in” and “zoom out” of images and video displayed on the screen 102.

The table 100 is able to receive and send data from and to external devices. In FIG. 1, a micro USB port 104 provides conventional universal serial bus or USB connectivity for the device 100. As shown in FIG. 2, other interfaces to external devices include so-called I.E.E.E. 802.11(a)/(b)/(g) and (n)-compliant “Wi-Fi” and conventional Ethernet. The ability to receive data files representing “previously-captured” images and “previously-captured” video images imbues the tablet 100 with the ability to playback and zoom video that the tablet 100 obtains from other sources.

The display screen 102 is a multi-touch, capacitive screen. In one embodiment, the display screen 102 has a full or “native” resolution of 1024×600 picture elements or “pixels.” Stated another way, the display screen has 1024 individually addressable picture elements or pixels in the horizontal or “X” direction, in each of six hundred rows that are arranged above each other the vertical or “Y” direction. The screen 102 is thus capable of displaying, without scaling or compression, digital images having of 1024×600 image elements. Those of ordinary skill in the art recognize that digital images having different numbers of image elements in either the horizontal direction or the vertical require image processing to either crop or delete excess image elements or add image elements, if a full screen image on the display screen 102 is desired.

FIG. 2 is a block diagram of a wireless communications system 200. The system 200 is comprised of a conventional wireless data network 202. The network 202 provides wireless connectivity to various types of portable, wireless communications devices. One such device is the table 100 shown in FIG. 1, which is also considered herein to be a portable communications device. Another wireless communications device operable with the network 202 is a so-called “smart phone” 204.

The wireless network 202 also provides connectivity to various communication endpoints. Two communication endpoints are exemplified in FIG. 2 by a mobile TV source 206 or a source of streaming video 208.

Devices that are compatible with the network 202 are able to at least receive radio frequency signals carrying data representing previously-captured video images. As used herein, the term “previously captured image” and “previously-captured video” means an image or video respectively, either captured by a camera, or generated by a graphics device such as a computer, not connected to, part of, or within, the tablet 100 or smart phone 204.

As used herein, “video” is considered herein to be comprised of a series or sequence of still image frames, each image frame being comprised of a predetermined number of individual image elements such that when the image frames are displayed on a display device they represent or depict scenes in motion. In the case of images captured by a digital camera, the number of image elements in an image frame will depend on the number of individual picture elements in the camera that captured the images. Image frames with relatively large numbers of image elements will have greater detail in them than will image frames will relatively small numbers of image elements.

If the number of image elements in a digital image is greater than the number of picture elements that a display screen 102 can display, some image elements are discarded or subtracted in order to display the image on the display device. Conversely, if the number of image elements in a digital image is less than the number of picture elements that a display screen 102 can display, image elements can be added to fill the display device or a black band can be used to “fill” the portion of the display device picture elements not needed to display an undersized image.

The display screen 102 of the portable communications device 100 has a display size or viewable image size that is the actual amount of screen space available to display a picture, video or working space and does not include screen area obscured by the frame 106 of the device 100. In one embodiment, the display screen 102 has six hundred horizontal rows, with each row containing 1024 individual picture elements. The maximum displayable size of an image is thus an image having 1024 picture elements in the horizontal or “X” direction and six hundred picture elements in the vertical or “Y” direction. A still image or video images having more or less than 1024×600 picture elements thus requires cropping or filling respectively in order to fill the display 102 to its maximum viewable image size. Cropping an image and the filling or adding of image elements can also be used to create the effects of an image being decreased in size or “zoomed out” and increased in size or “zoomed in.” As used herein, the term “zoom” refers to manipulation of a displayed image or images, i.e., changing the size of one or more images displayed on the display screen 102, in order to make object's in a displayed image or images appear to be closer to, or farther from, an observer viewing the display screen 102. An object in a displayed image can be made to appear to increase or decrease in size by adding or subtracting image elements of the object, and which when displayed by a display device, depict the object as being larger or smaller respectively.

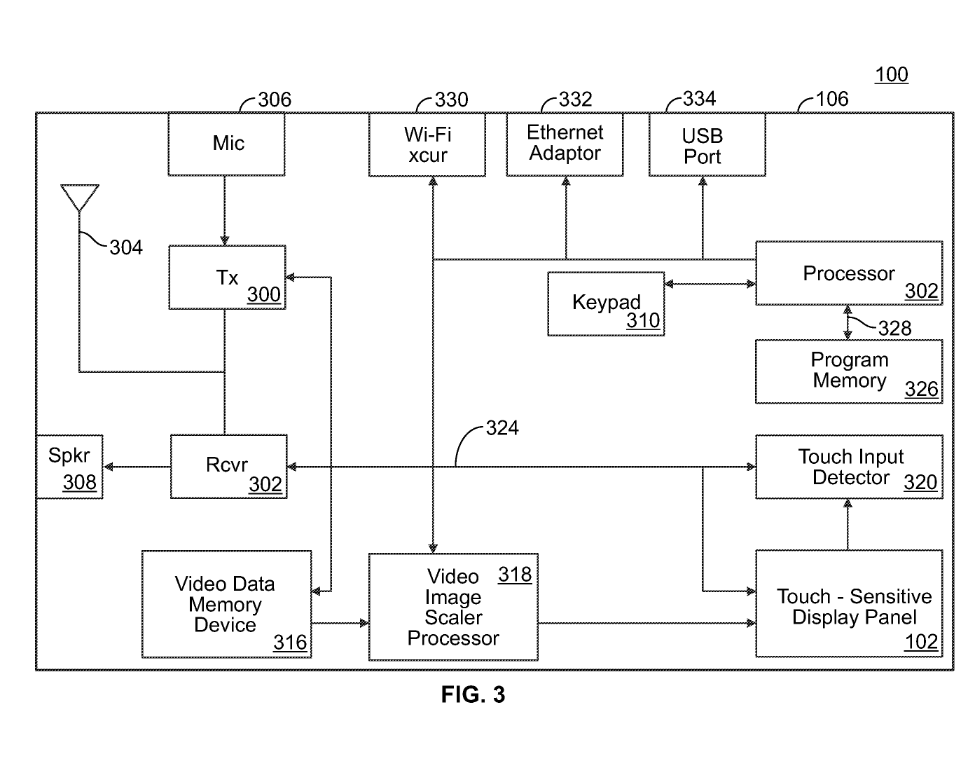

FIG. 3 is block diagram of functional structures within the portable communications device 100, which provides among other things, wireless two-way communications via the network 202. A transmitter 300 and a receiver 302 are coupled to an antenna 304 through a conventional prior art duplexer, omitted from the figure for simplicity.

A conventional microphone 306 detects audio signals and couples them into the transmitter 300. Audio signals are modulated onto a carrier generated by the transmitter and radiated from the antenna 304. A speaker 308 coupled to the receiver 302 generates audible sound waves from audio signals recovered from RF signals received from the antenna 304. The transmitter 300, receiver 302, microphone 306 and speaker 308 imbue the portable communications device 100 with two-way communications functionality. An optional keypad 310 is coupled to a processor 312 through a conventional bus 314.

As used herein, a “bus” is considered to be a set of electrically-parallel conductors that connect components of computer system to each other. A bus allows the transfer of electric impulses from one component connected to the bus to any other component connected on the bus.

In FIG. 3, which is for purposes of illustration only, the receiver 302 receives radio-frequency signals that carry data. Such data can include image data representing previously-captured still images and video. The receiver 302 is therefore coupled to a video data memory device 316, conventional in nature, wherein data representing images and full motion video is stored for subsequent playback or display.

Video image data can also be obtained or received from external sources via other interfaces. Such interfaces include, but are not limited to, a transceiver 330 compatible with the well-known I.E.E.E. 802.11 standards, also known as “Wi-Fi.” An Ethernet adapter 332 and an USB port 334 also provide the ability to receive video data files, which can be routed through the processor 302 and into the video data memory device 316 via the first bus 324.

A video image scaler 318 is coupled to the video data memory 316. The scaler 318 is configured to be able to read data directly from the video data memory 316 itself and provide that data to the touch-sensitive display panel 102. The video image scaler 318 is configured to process data that it reads from the video data memory 316 and thereafter send the processed data to the display screen 102 where it is used to generate an image that can be perceived from the display screen 102. The scaler 318 thus does not modify data representing original content but instead modifies the data “on the fly” and presents the modified data, which will render a modified image. Equally important is that the scaler 318 processes data of different formats and which represents images that were obtained from or captured by devices external to, i.e., other than, the portable communications device 100 itself.

The scaler 318 is configured to convert video image file formats as they are read from the video data memory device 316. By way of example, the scaler 318 is configured to convert so-called “AVI” format filed to MPEG-3 or MPEG-4 format files.

The video image scaler 318 is configured to be able to read different sections of video data memory, and thus different portions of a digital image or images stored therein, via different memory ports, not shown but well known to those ordinary skill in the art. The video image scaler 318 is thus capable of reading data from the video data memory 316 which represents a portion of a full frame image stored in the video data memory 316 and is capable of “expanding” the data to fill, or over-fill the maximum image size displayable by the display panel 102.

Processes or methods of “zooming-in” or enlarging a portion of a digital image are well-known but almost all of them require image elements to be generated and added to an original, captured image. New image elements can be derived using a variety of different algorithms well known in the art. Description of them is therefore omitted for brevity.

In FIG. 3, data output from the video image scaler 318 is selected and arranged such that the touch-sensitive display screen 102 is fully filled. In the preferred embodiment, the display screen has a resolution of 1024×600 pixels. It is therefore capable of displaying up to 1024 individual picture elements, “horizontally” across each of six hundred “vertical” rows.

A touch input detector 320 is depicted in the figure to denote that when a user presses one or more fingers up against the touch-sensitive display panel 102, the users touch or tactile input is detected 320. The tactile input can thus be acted upon or processed to control the adjustment or alteration of images displayed on the panel 102.

The various structures shown in FIG. 3 (transmitter 300, receiver 302, video data memory 316, video image scaler 318, display panel 102 and the touch input detector 320) are connected to the processor 312 via a first bus that is identified in the figure by reference numeral 324. The processor 312 is thus able to communicate with each and every structure coupled to the bus 324.

Using the structure depicted in FIG. 3, the processor 302 is able to detect or “read” an input gesture on the display screen 102 via the touch input detector 320 and thereafter issue commands to the video image scaler 318 to effectuate the addition as well as subtraction of picture elements to and from each image that forms video on the display screen 102.

The operations that the processor 302 performs are determined by program instructions that the processor 312 obtains from a program memory 326 and executes. As shown in the figure, the program memory 326 and the processor 312 communicate with each other through a second bus 328. A second bus is depicted because in one embodiment, the processor 312 and the program memory 326 are co-located on the same silicon die. The bus 328 is thus comprised of various interconnections between the two functional devices on that die. In alternate embodiment, the program memory 326 is one or more semi-conductor memory devices, separate and apart from the processor 312. In such an embodiment, the second bus 328 is thus a conventional address/control/data bus, well-known to those of ordinary skill in the art.

Executable instructions stored in the program memory 326 imbue the processor 312 with the ability to read and detect tactile inputs or gestures that are themselves detected by the touch input detector 320. Such gestures and input include but are not limited to so-called pinching and un-pinching gestures.

As used herein, a pinching gesture is considered to be the simultaneous contact of two or more fingers against the surface of the display screen 102 and their lateral translation toward each other in a single, substantially continuous motion. As its name suggests, a pinching gesture is reminiscent of the act of pinching an object with one's thumb and forefinger. “Un-pinching” is considered to be the opposite motion, i.e., two fingers placed against the display screen 102 and spatially separated from each other while against the surface of the display screen 102.

All tactile inputs to the touch-sensitive display panel 102 necessarily occur at some location on the panel's surface. Where someone places his or her fingers against the display panel 102 can be readily determined as “x” and “y” coordinates using conventional techniques. The act of touch the display panel with two fingers and separating them from each other thus defines a location on the display panel and defines opposing vertices of a rectangle, the diagonal dimension of which is equal to the separation distance between the two fingers.

Instructions stored in the program memory 326 cause the processor 312 to “read” the starting location of a tactile input to the display panel 102 and the separation distance between the opposing vertices of a rectangle defined by the separation between two fingers as they are moved apart from each other and maintained in contact with the display screen surface. The contact and un-pinching motion thus define an enlargement or reduction factor, percentage or dimension, to be applied to subsequently-displayed image frames.

Executable instructions in the program memory cause the processor to issue instructions to the video image scaler 318, which cause the scaler 318 to create or generate additional pixels using the pixels enclosed within the selected portion of the display panel 102 for each and every subsequent image that is read from the video data memory 316 and displayed on the display panel 102. The image frames stored in memory are thus read from the video data memory 316 and scaled to increase or decrease the size of objects depicted in the captured images. The video image scaler 318 thus is configured to provide continuous “zoom-in” (captured object image enlargement) and “zoom-out” (captured object image reduction) functionality to video regardless of when and where the video images were recorded and how they were recorded. Unlike prior art devices, which are limited to operating on video captured by a device itself, the portable communications device 100 depicted in the figures and described above is able to operate on any source of video image information and provides the ability to zoom-in or zoom-out on areas of interest in a particular video stream or portion thereof.

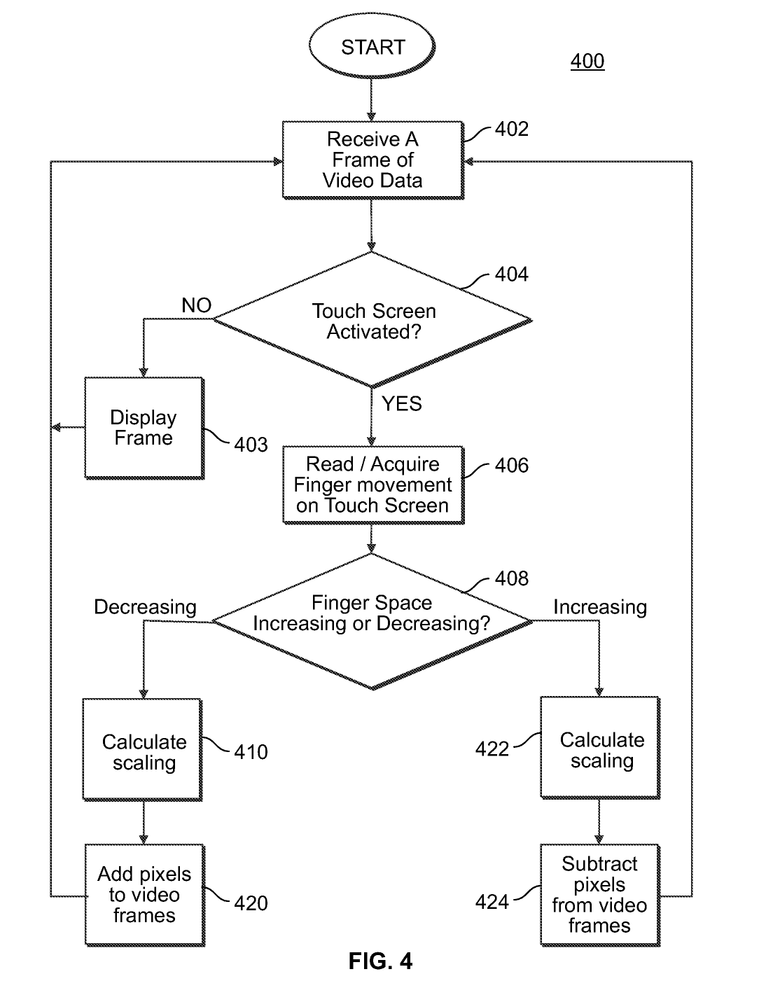

FIG. 4 depicts steps of a method for providing zoom-in and zoom-out functionality to any stream of video images. In a first step 402 a frame of video data is obtained or received such as from a video data memory device 318 depicted in FIG. 3. A test is executed at step 404 for activation or contact with the touch screen. If at step 404 it is determined that the touch screen has been contacted or activated the location of the tactile input and the movement of the fingers on the screen are determined are determined at step 406.

The movement of fingers away from each other provide while they are in contact with a touch-sensitive display screen provides a scaling factor or number, usable by the video image scaler 318 to increase or decrease the size of a displayed image by adding or subtracting pixels from the image information obtained from the video data memory 316. The size or extent to which fingers are separated from each other in a un-pinching movement or moved toward each other in a pinching movement thus provides a scaling factor for the video image scaler 318. That same scaling factor is applied to all subsequently obtained images created from the data stored in the video data memory 316. At step 408, a decision or test is executed to determine whether or not the finger space is increasing or decreasing. The direction of movement and the distance that the two fingers are separated from each other thus provides the aforementioned scaling factor.

At step 408, if the finger spacing is increasing or decreasing if a scaling factor is generated accordingly. In the case of an increasing separation distance, at step 410 a scaling factor is calculated that is used to determine the number of pixels to add to the frame at step 420. Pixels within the selected region of the display are augmented by additional pixels that are generated to make the subsequent video image frames appear to be zoomed-in or enlarged.

If the finger spacing is decreasing, at step 422 a calculation is made to determine the number of pixels or percentage of pixels that extracted or removed from the selected image field at step 424. Subsequent video image frames are processed by repeating the steps as shown.

Those of ordinary skill in the art will recognize that while the video image scaler 318 is depicted as a separate structural element, the functions described herein as being performed by the video image scaler 318 can in fact be performed by program instructions residing in the program memory 326 or another program store. In such an embodiment, the program instructions thus act as and are equivalent to structure identified and described herein as the video image scaler 318.

Similarly, the touch input detector 320 and the functions it performs are depicted as being a separate structural element but can instead be accomplished by program instructions as well. In such an embodiment, program instructions that provide the functionality described herein and attributed to the touch input detector 320 in fact comprise structure.

Stated another way, the functions provided by the structures described above can in fact be provided by instructions or software for one or more processors operatively coupled to at least a video data memory device and a touch-sensitive display panel 102.

The foregoing description is for purposes of illustration only. The true scope of the invention is set forth in the appurtenant claims.

What is claimed is:

1. A portable communications device comprised of:
a touch-sensitive display device (display device) having a first number of rows of picture elements and a second number of columns of picture elements, the picture elements being configured to emit light to generate an image, the display device configured to display video that is embodied as successive and temporally-adjacent frames of images, each image frame being comprised of a first number of image element rows and a second number of image element columns, a plurality of image elements of each image frame being displayed by the display device by corresponding picture elements;
a processor coupled to the touch-sensitive display device, the processor being configured to detect an input gesture on the touch-sensitive display device, and configured to add new image elements to, and subtract image elements from, image frames obtained from a video data memory coupled to the processor, added and subtracted image elements increasing or decreasing respectively, the size of at least a portion of each image subsequently displayed by the display device picture elements, the number of picture elements added to video image frames and the number of picture elements subtracted from video image frames being determined responsive to the input gesture.

2. The portable communications device of claim 1, further comprised of a video data memory wherein data representing video image frames is stored, and wherein the processor is configured to be responsive to an un-pinching input gesture, an un-pinching input gesture causing the processor to effectuate the addition of a number of picture elements to each video image frame obtained from the video data memory after the input gesture occurs, the number of added picture elements corresponding to a size of the input gesture and effectuating correspondingly increased-size video image frames after the input gesture, each increased-size video image frame having additional image element rows and additional image element columns, the number of image element rows and image element columns in each increased-size video image frame being greater than the first number of picture element rows and the second number of picture element columns respectively in the display device.

3. The portable communications device of claim 1, wherein the processor is responsive to a pinching input gesture, a pinching input gesture causing the processor to subtract picture elements from each video image frame after the pinching input gesture and thereby decrease the size of a plurality of successive and temporally-adjacent frames of images displayed after the un-pinching gesture is detected, the decreased size of the plurality of successive images being less than the first maximum image size.

4. The portable communications device of claim 1, further comprised of a radio frequency receiver, configured to be able to receive radio frequency signals carrying data that represents video image frames.

5. The portable communications device of claim 4, wherein the receiver is additionally configured to store in a video data memory device, data that represents previously-captured images.

6. The portable communications device of claim 2, further comprising a video scaling engine configured to generate new picture elements for each of a plurality of successive and temporally-adjacent image frames responsive to a first type of input gesture, the video scaling engine being additionally configured to delete picture elements from each of a plurality of successive and temporally-adjacent image frames, responsive to a second type of input gesture.

7. The portable communications device of claim 1, wherein the processor is additionally configured to effectuate the conversion of a previously-captured video data from a first format to a second format, prior to display of the video data on a display device.

8. The portable communications device of claim 1, wherein the touch-sensitive display and processor are configured to be responsive to a tactile input comprised of a movement of at least two fingers relative to each other, while the at least two fingers simultaneously make physical contact with the touch-sensitive display.

9. A portable communications device comprised of:
a touch-sensitive display device having a maximum viewable image size, video displayed on the display device being comprised of a series of temporally-adjacent images, each temporally-adjacent image being comprised of picture elements that are displayed within at least part of the maximum viewable image size;
a video data receiver, configured to receive previously-captured video data;
a video data storage device coupled to the video data receiver and the touch-sensitive display device, the video storage device being configured to store previously-captured video data for playback on the touch-sensitive display device; and
a processor coupled to at least the touch-sensitive display device and configured to receive from the touch-sensitive display device, a tactile selection of a portion of the maximum viewable image size, the processor being additionally configured to at least partially fill the maximum viewable image size of the display device with at least part of the selected portion of the viewable image.

10. The portable communications device of claim 10, wherein the tactile selection of a portion of the maximum viewable image size is comprised of a rectangular-shaped region of an at least one image displayed within the maximum viewable image size and wherein the processor is additionally configured to generate picture fill elements which are used to at least partially fill the maximum viewable image size.

11. The portable communications device of claim 10, wherein the video data storage device is configured to receive and store previously-captured video data obtained from a video data recording device external to the portable communications device.

12. The portable communications device of claim 10, wherein the processor is additionally configured to convert the previously-captured video data from a first format to a second format.

13. The portable communications device of claim 10, wherein the touch-sensitive display and processor are configured to be responsive to a tactile input comprised of a movement of at least two fingers relative to each other, while the at least two fingers simultaneously make physical contact with the touch-sensitive display.

14. A method of displaying video on a portable communications device having a touch-sensitive display device capable of displaying video by generating and displaying a plurality of successive images, the touch-sensitive display device comprised of a first number of image display elements, the method comprised of:
receiving image data, which represents a series of temporally-adjacent images recorded by an image capture device;
generating video on the touch-sensitive display device, by displaying a series of temporally-adjacent images using the received image data;
selecting a portion of at least one displayed image of the series of temporally-adjacent images by a tactile input to the touch-sensitive display device; and
generating and adding new picture elements to picture elements within the selected portion of the at least one displayed image of the series of temporally-adjacent images.

15. The method of claim 14, wherein the step of receiving image data includes the step of receiving images recorded by an image capture device external to the portable communications device.

16. The method of claim 14, wherein the step of generating new picture elements includes generating new picture elements by averaging adjacent picture elements.

17. The method of claim 14, wherein the step of generating new picture elements includes generating new picture elements by evaluating neighboring picture elements and adding a new picture element based on surrounding picture elements.

18. The method of claim 14, wherein the step of selecting a portion of at least one displayed image by a tactile input is comprised of:
touching the touch-sensitive display with at least two fingers and simultaneously moving the at least two fingers away from each other.

19. The method of claim 15, wherein the step of receiving image data is comprised of receiving image data wirelessly.

20. The method of claim 16, wherein the step of receiving image data is comprised of receiving image data from a wired connection.
